(19) United States
(12) Patent Application Publication
(10) Pub. No.: US 2005/0099923 A1
(43) Pub. Date: May 12, 2005

(54) Optical disk device, semiconductor device, optical disk and recording method

(76) Inventors: Ryutaro Futakuchi, Hirakata city (JP); Kenji Koishi, Sanda city (JP)

Correspondence Address: WENDEROTH, LIND & PONACK, L.L.P., 2033 K STREET N. W., SUITE 800, WASHINGTON, DC, 20006-1021, US

(21) Appl. No.: 10/968,913

(22) Filed: Oct. 21, 2004

(30) Foreign Application Priority Data
Nov. 11, 2003 (JP) 2003-380881

(51) Int. Cl. G11B 7/00

(52) U.S. Cl. 369/59.11; 369/116

(57) ABSTRACT

An object of the present invention is to provide an optical disk device which is capable of forming a recording mark at a more suitable position by using a more suitable recording compensation value.

To achieve the object above, the optical disk device of the present invention is a device which records recording data by forming a mark on an optical disk 9 by using a recording pulse 1 in accordance with the recording data, and includes an optical pickup and a control unit. The optical pickup includes a laser 7 which emits a laser beam 8 in accordance with a recording pulse 1 and an optical component to guides a laser beam 8 to the optical disk 9. The control unit controls the emission of the laser 7 by using a recording compensation value predetermined in accordance with an emission property of the laser 7.

### BACKGROUND OF THE INVENTION

1. Field of the Invention

The present invention relates to an optical disk device, particularly an optical disk device for recording recording data on an optical disk. Furthermore, the present invention also relates to a semiconductor device, an optical disk and a recording method.

2. Description of the Prior Art

A conventional technique for an optical disk device, more precisely, a technique related to a recording compensation when data is recorded by driving a laser using a recording pulse, which changes its pulse width and its pulse interval in accordance with the recording data, and by forming a mark on an optical disk, is as follows.

For example, there is a technique for determining the shift amount of the front-end or the back-end of the formed mark edge, that is, the recording compensation value, based on a measurement result of the width of the recording pulse and the recording intervals by measuring the width of the recording pulse and the recording intervals (see Japanese unexamined patent publication No. H05-266481, for example).

In such technique, for example, by using a device such as a programmable delay line and setting the amount of delay in accordance with the recording compensation value, the position of the front-end or the back-end of the forming recording mark can be determined by shifting the front-end or the back-end of the recording pulse.

In addition, the following technique is described in the same publication. A final recording compensation value is determined by including both the effects of recording-power sensitivity of the optical disk and the surrounding temperature, and then the determined value is used as a shift amount of the front-end or the back-end of the formed mark.

Recently, however, along with development of a high-speed optical disk, it has been required to form a recording mark at a more suitable position by using a more suitable recording compensation value.

In other words, when the conventional technique is used, a shift in the forming position of a recording mark increases if a high-speed optical disk is used.

### SUMMARY OF THE INVENTION

Therefore, an object of the present invention is to provide an optical disk device which is capable of forming a recording mark at a more suitable position by using a more suitable recording compensation value.

According to a first aspect of the present invention, an optical disk device for recording recording data by forming a mark on an optical disk using a recording pulse in accordance with the recording data is provided, which comprises an optical pickup and a control unit. The optical pickup includes a laser generation unit which emits a laser light in accordance with the recording pulse and an optical component which guides the laser light to the optical disk. The control unit controls the emission at the laser generation unit by using a recording compensation value determined in accordance with an emission property of the laser generation unit.

The recording pulse, for example, is generated so as to change its pulse width or pulse interval in accordance with the recording data. The recording compensation value, for example, is a value which compensates the timing of emitting the laser light relative to the recording pulse.

With the optical disk device of the present invention, forming a mark is possible by using the recording compensation value in accordance with the emission property of the laser. Therefore, performing a more suitable recording compensation and forming a mark at a more suitable recording position becomes possible.

According to a second aspect of the present invention in the optical disk device, the emission property is a leading edge period or a trailing edge period during the emission at the laser generation unit.

With the optical disk device of the present invention, forming the mark becomes possible by using the recording compensation value in accordance with the leading edge period or the trailing edge period of the laser. Therefore, for example, controlling the start of the emission of the laser becomes possible by using the recording compensation value in accordance with the leading edge period. In addition, for example, controlling the end of the emission of the laser becomes possible by using the recording compensation value in accordance with the trailing edge period.

According to a third aspect of the present invention in the optical disk device, the device comprises a memory unit storing a plurality of candidates for the recording compensation value which are determined for each of a plurality of leading edge periods having different values or each of a plurality of trailing edge periods having different values. The control unit determines the recording compensation value which is used in controlling the emission at the laser generation unit, by choosing the value from the plurality of candidates for the recording compensation value stored in the memory unit, based on the leading edge period or the trailing edge period during the laser generation unit emission.

The control unit stores a plurality of candidates for the recording compensation value in accordance with a plurality of leading edge periods or in accordance with a plurality of trailing edge periods, and they have a table format, for example. Furthermore, the control unit determines the recording compensation value which is actually used during the emission at the laser generation unit based on the candidate for the recording compensation value.

According to a fourth aspect of the present invention in the optical disk device, the device further comprises a measurement unit measuring the leading edge period or the trailing edge period during the emission at the laser generation unit. The control unit obtains the leading edge period or the trailing edge period during the emission at the laser generation unit from the measurement unit.

The control unit determines the recording compensation value, which is used in controlling the emission at the laser generation unit, from a plurality of candidates for the recording compensation stored in the memory unit based on an actually measured leading or trailing edge period at the laser generation unit.

In the optical disk device of the present invention, because the emission property of the laser generation unit is actually measured, more precise control of the emission of the laser emission unit becomes possible. Furthermore, it is also possible to determine the correct recording compensation value for each of a plurality of optical disk devices with different emission properties in accordance with each of the emission properties.

According to a fifth aspect of the present invention in the optical disk device, the control unit chooses a candidate for the recording compensation value as the recording compensation value from the plurality of candidates for the recording compensation value stored in the memory unit, wherein the candidate is determined in accordance with a closest value of the leading edge period or the trailing edge period during the emission at the laser generation unit.

In the optical disk device of the present invention, the candidate for the recording compensation value determined in accordance with the closest value of the leading edge period or the trailing edge period during the emission at the laser generation unit is chosen as the recording compensation value. Therefore, controlling the emission at the laser emission unit is possible by using a more suitable recording compensation value.

According to a sixth aspect of the present invention in the optical disk device, the control unit chooses two candidates for the recording compensation value from the plurality of candidates for the recording compensation value stored in the memory unit, wherein the two candidates are determined in accordance with two closest values of the leading edge period or the trailing edge period during the emission at the laser generation unit, and determines an average value of the two chosen candidates for the recording compensation value as the recording compensation value.

Here, the average value can be a simple average or a weighted average.

In the optical disk device of the present invention, in order to determine the recording compensation value by using the two candidates for the recording compensation value, controlling the emission of the laser emission unit becomes possible by using the more suitable recording compensation value. In addition, because the recording compensation value actually used can be calculated by providing only a small number of recording compensation values, reducing the capacity of a memory and the like that are necessary for storing the candidates of the recording compensation value, becomes feasible.

According to a seventh aspect of the present invention in the optical disk device, the control unit obtains a plurality of candidates for the recording compensation value from the optical disk, wherein candidates are determined in accordance with each of a plurality of leading edge periods having different values or each of a plurality of trailing edge period having different values, and the control unit determines the recording compensation value, which is used in controlling the emission at the laser generation unit, from the plurality of candidates for the recording compensation value based on the leading edge period or the trailing edge period during the emission at the laser generation unit.

Here, the optical disk stores a plurality of candidates for the recording compensation value in accordance with a plurality of leading edge periods or in accordance with a plurality of trailing edge periods and they have a table format, for example. Furthermore, the control unit reads out the candidate for the recording compensation value from the optical disk, and determines the recording compensation value which is actually used during the emission at the laser generation unit.

In the optical disk device of the present invention, the candidate for the recording compensation value is read out from the optical disk. Therefore, the candidate for the recording compensation value need not be stored in the optical disk device beforehand, and the memory and the like which is necessary for memorizing the candidate for the recording compensation value can be reduced.

According to a eighth aspect of the present invention in the optical disk device, the device further comprises a measurement unit measuring the leading edge period or the trailing edge period during the emission at the laser generation unit, and the control unit obtains the leading edge period or the trailing edge period during the emission at the laser generation unit from the measurement unit.

The control unit determines the recording compensation value, which is used in controlling the emission at the laser generation unit, from a plurality of candidates for the recording compensation value which are read out from the optical disk based on the actually measured leading edge period or trailing edge period of the laser generation.

In the optical disk device of the present invention, because the emission property of the laser generation unit is actually measured, it is possible to control the emission at the laser generation unit more appropriately. Furthermore, for each of the plurality of optical disk devices having lasers with different emission properties, it is possible to determine the correct recording compensation value in accordance with each of the emission properties.

According to a ninth aspect of the present invention in the optical disk device, the control unit chooses a candidate for the recording compensation value as the recording compensation value from the plurality of candidates for the recording compensation value obtained from the optical disk, wherein the candidate is determined in accordance with the closest value of a leading edge period or a trailing edge period during the emission at the laser generation unit.

In the optical disk device of the present invention, a candidate for the recording compensation value determined in accordance with the closest value of the leading edge period or the trailing edge period during the emission at the laser generation unit is chosen as the recording compensation value. Therefore, controlling the emission at the laser emission unit by using a more suitable recording compensation value is possible.

According to a tenth aspect of the present invention in the optical disk device, the control unit chooses two candidates for the recording compensation value from the plurality of candidates for the recording compensation value obtained from the optical disk, wherein the two candidates are determined in accordance with two closest values of the leading edge period or the trailing edge period during the emission at the laser generation unit, and the control unit determines an average value of the two chosen candidates for the recording compensation value as the recording compensation value.

Here, the average value can be a simple average or a weighted average.

In the optical disk device of the present invention, because the recording compensation value is determined by using the two candidates for the recording compensation value, controlling the emission at the laser emission unit is possible by using a more suitable recording compensation value. In addition, because it is possible to calculate the actually used recording compensation value by storing fewer recording compensation values, the capacity of a memory or the like which is necessary for memorizing the candidate for the recording compensation value can be reduced.

According to an eleventh aspect of the present invention, a semiconductor device for controlling an emission timing at the laser generation unit is provided, in which the laser light is emitted in accordance with a pulse signal, and the device comprises an amount-of-delay determining unit and a delay execution unit. The amount-of-delay determining unit determines the amount of delay of the pulse signal using a predetermined recording compensation value in accordance with an emission property of the laser generation unit, and the delay execution unit delays the pulse signal using the amount of delay determined at the amount-of-delay determining unit.

According to the semiconductor device of the present invention, finding the pulse signal delay is possible by using the recording compensation value determined in accordance with the emission property of the laser generation unit. Thus, according to the emission property of the laser generation unit, it is possible to control the emission timing more appropriately.

According to a twelfth aspect of the present invention, an optical disk on which recording data is recorded by forming a mark by a laser emission is provided, on which each of a predetermined plurality of candidates for recording compensation values are recorded beforehand on a predetermined area in accordance with a plurality of different values of a laser emission property.

In the optical disk of the present invention, giving the candidate for recording compensation value to the optical disk device which performs recording on optical disks is possible. Thus, the candidate for the recording compensation value need not be stored in the optical disk device beforehand, and memory and the like which is necessary for memorizing the candidate for the recording compensation value can be reduced. In addition for example, by setting the candidate for the recording compensation value relative to the material of the optical disk, the more suitable recording compensation value can be determined in the optical disk device.

According to a thirteenth aspect of the present invention, a recording method used in an optical device for recording the recording data by forming a mark on an optical disk using a recording pulse in accordance with recording data is provided, which comprises an obtaining step and a controlling step. In the obtaining step, the emission property of a laser generation unit which emits the laser light relative to the recording pulse is obtained. In the controlling step, the emission at the laser generation unit is controlled by using the recording compensation value determined in accordance with the emission property.

The recording pulse is, for example, generated so as to change its pulse width or pulse interval in accordance with the recording data. The recording compensation value is, for example, a value which compensates the timing of emitting the laser light relative to the recording pulse.

With the recording method of the present invention, forming a mark becomes feasible using a more suitable recording compensation value in accordance with an emission property of the laser. Thus, performing suitable recording compensation and forming a mark at a suitable recording position becomes possible.

With the optical disk device of the present invention, forming a recording mark at a more suitable position is possible by using a more suitable recording compensation value.

### BRIEF DESCRIPTION OF THE DRAWINGS

FIG. 1 is a block diagram showing an optical disk device of Embodiment 1 of the present invention.

FIG. 2 is a flow chart showing the process of setting a recording compensation value for an optical disk device of Embodiment 1 of the present invention.

FIG. 3 is a flow chart showing the process of setting a recording compensation value for an optical disk device of Embodiment 2 of the present invention.

FIG. 4 is a flow chart showing the process of setting a recording compensation value for an optical disk device of Embodiment 3 of the present invention.

FIG. 5 is a block diagram showing an optical disk device of Embodiment 4 of the present invention.

FIG. 6 is an explanatory diagram showing drawbacks of an optical disk device.

### DESCRIPTION OF THE PREFERRED EMBODIMENTS

(Overview of the Invention)

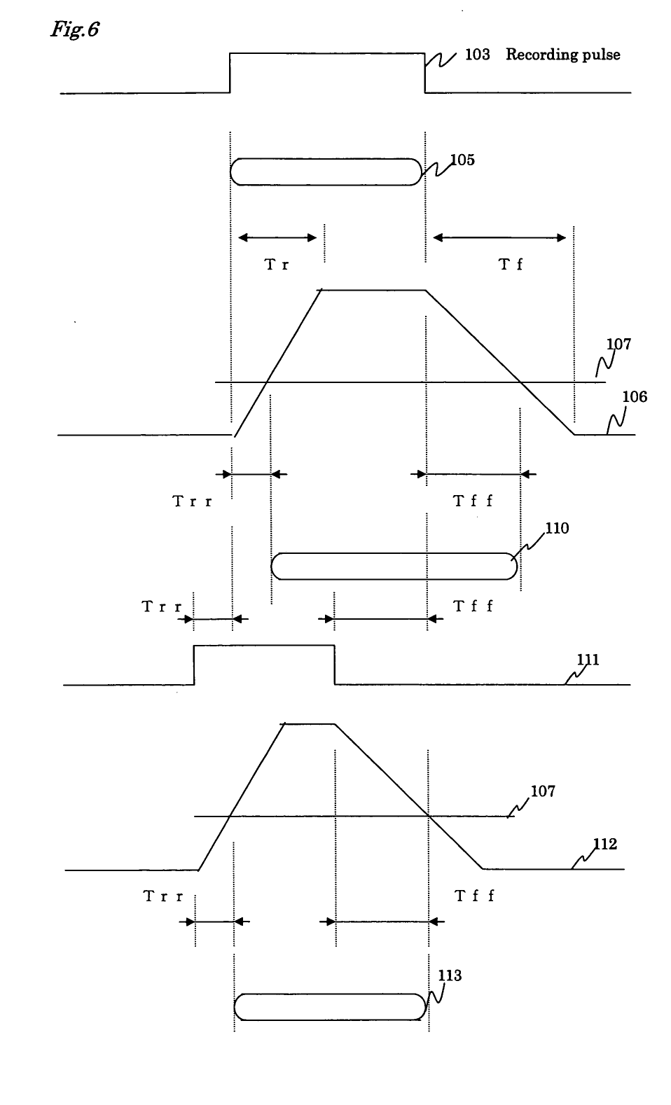

With reference to FIG. 6, a problem of the conventional technique discovered by the present inventors and an overview for solving the problem of the present invention will be described.

Forming a Recording Mark According to the Conventional Technique

In FIG. 6, reference numeral 103 is a recording pulse (before applying any recording compensation), and reference numeral 105 is an ideal recording mark in which the start position and the end position of the recording pulse 103 are identical to the front-end and the back-end of the mark, respectively.

However, when the laser is driven by such recording pulse 103, the recording emission level of the laser changes as shown in 106.

A recording mark is formed when the recording emission level of the laser is over a threshold level 107. Because of the existence of the threshold level 107 which contributes to forming the recording mark, when the laser is driven by the recording pulse 103, the actual recording mark is formed as reference numeral 110. In other words, the recording mark 110 becomes longer than the ideal recording mark 105, and the front-end of the mark 110 is formed by delaying by the time Trr from a start position of the recording pulse 103 and the back-end is formed by delaying by the time Tff from an end position of the recording pulse 103. Here, Trr is the period that the recording emission level 106 is over the threshold level 107 from the start position of the recording pulse 103. Tff is the period that the recording emission level 106 is below the threshold level 107 from the end position of the recording pulse 103. In addition, in FIG. 6, Tr is a leading edge and Tf is a trailing edge of the recording emission level 106.

Forming a Recording Mark by Applying the Present Invention

In the situation as shown in FIG. 6, the recording compensation of the present invention is performed as follows.

Specifically, the start position of the recording pulse 103 is brought forward by the time Trr and the end position is brought forward by the time Tff. Note that, because the operation of putting ahead is impossible, the recording pulse 103 before applying the recording compensation is input into a device such as a programmable delay line. And when the maximum amount of delay is defined as T, the amount of delay of the programmable delay line to be set (hereinafter referred to as the setting amount) is determined by subtracting the desired putting ahead time from the maximum amount of delay T.

In this situation, because the recording compensation value corresponding to the front-end of the formed recording mark is Trr, the setting amount of delay of the programmable delay line is determined by subtracting Trr from the maximum amount of delay T. In addition, because the recording compensation value corresponding to the back-end of the formed recording mark is Tff, the setting amount of delay of the programmable delay line is determined by subtracting Tff from the maximum amount of delay T.

In FIG. 6, the timing of the recording pulse having the above-mentioned recording compensation becomes that shown as reference numeral 111 relative to the recording pulse 103 before the recording compensation. In addition, the recording emission level of the laser corresponding to the recording pulse 111 after applying the recording compensation changes as shown by reference numeral 112. Therefore, due to the existence of the threshold level 107, the recording mark is formed as shown by reference numeral 113. As shown in FIG. 6, the recording mark is formed with the same timing as the ideal recording mark 105, in other words, the length, the front-end and the back-end are formed with the same timing as the mark 105.

Note that, in FIG. 6, the horizontal axis is time. Thus, for example, although the length of the ideal recording mark 105 is also described as a time unit, in order to describe the length of the actually formed mark on the optical disk as an interval unit, the time unit can be transformed to an interval unit by using the velocity of the recording beam having the recording emission level 106 when it scans the optical disk.

Hereinafter, embodiments of the present invention will be described by referring to figures.

### Embodiment 1

Structures

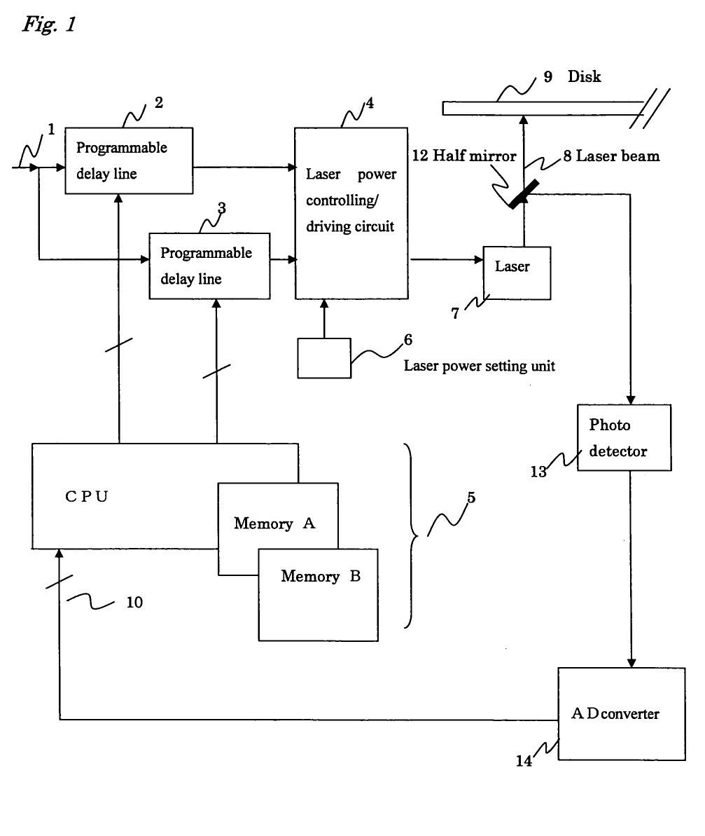

FIG. 1 shows an optical disk device of Embodiment 1 of the present invention, particularly a part of the structure related to the recording compensation.

In FIG. 1, reference numeral 1 is a recording pulse. The recording pulse 1 is input into each of a programmable delay line 2 and a programmable delay line 3 in which the amount of delay can be set arbitrarily. The programmable delay line 2 delays the recording start position of the recording pulse 1, and the programmable delay line 3 delays the recording end position of the recording pulse 1.

In addition, reference numeral 5 is a CPU for controlling the setting of a predetermined amount of delay in accordance with the programmable delay line 2 and the programmable delay line 3, and a memory A and a memory B are included inside of the delay lines. Note that, CPU 5 is not limited to having such structure, and can also be connected with the memory A and the memory B through a bus or a network.

In the memory A, for each of the lasers which are available for the optical disk device, a plurality of pairs of the leading edge period and the trailing edge period are stored. Note that, these leading edge periods and trailing edge periods are expressed as Tr1-TrN and Tf1-TfN, respectively.

In addition, in the memory B, the recording compensation value in accordance with each of the contents of the memory A, in other words, the different leading edge period (Tr1-TrN) and the trailing edge periods (Tf1-TfN) of the lasers, that is, the recording compensation values which are appropriate to each of the different leading edge period and the trailing edge period of the lasers are recorded beforehand. Note that, these recording compensation values are expressed as Trr1-TrrN and Tff1-TffN, respectively.

Thus, the memory A and the memory B perform as read-only memories, and the amount of delay, which needs to be set in accordance with the programmable delay line 2 and the programmable delay line 3, has values which are the result of subtracting any values of Trr1 to TrrN from T, and subtracting any values of Tff1 to TffN from T, where T is a maximum amount of delay.

Next, a way of determining the recording compensation value will be described. The recording compensation value is determined off-line beforehand. For example, by changing the setting value of the programmable delay line arbitrarily, the recording pulse sequences are actually recorded. Furthermore, reproducing properties (C/N, jitter and the like) of the recorded recording pulse sequences are evaluated, and the setting value is searched for as its reproducing property is optimized. As a result, the recording compensation value is calculated from the setting value of the programmable delay line. More specifically, a value which is obtained by subtracting the setting value of the search result from the maximum amount of delay of the programmable delay line is defined as the recording compensation value.

The recording pulse 1 of the delay process, provided by the programmable delay line 2 and the programmable delay line 3, is input into the laser power controlling/driving circuit 4. The laser power controlling/driving circuit 4 controls and drives the laser 7 with timing relative to the output of the programmable delay line 2 and the programmable delay line 3. In this situation, the level of the laser beam 8 emitted from the laser 7 is controlled by a laser-power setting unit 6. Furthermore, the laser beam 8 emitted from the laser forms a recording mark on the disk 9.

The laser beam 8 (particularly, the laser beam 8 during the recording emission) emitted by laser 7 is separated according to an appropriate ratio by a half mirror 12, then encoded into an electronic signal by a photo detector 13 and is then input into an AD converter 14.

Output data of the AD converter 14, in other words, the digital signal data transformed from the recording emission level of the laser beam 8 (emitted from the laser 7), is input into CPU 5 as the input data 10 with a predetermined data format.

In CPU 5, by using the obtained input data 10, the leading edge period Tr and the trailing edge period Tf of the laser 7 are obtained. For example, in CPU 5, a measurement function for the leading edge period Tr and the trailing edge period Tf of the laser 7 is programmed beforehand. More precisely, during the measurement process, a period from the emission start level to a constant emission state is Tr and a period from the constant emission state to an emission end level is Tf (like the recording emission level 106 shown in FIG. 6).

Note that, techniques for measuring various parameters of any electric signals, which are made by a combination of CPU and an AD converter, are well known. Realization of the technique is easy and its use in the above-mentioned Embodiment is no exception.

Note that, as previously mentioned, the input data 10 is the recording emission level of the laser beam 8, however, the data 10 can also be data corresponding to the leading edge period Tr and the trailing edge period Tf of the laser actually used 7. (Note that, as for Tr and Tf, see FIG. 6). For example, it is possible to measure the leading edge period or the trailing edge period of the laser 7 by observing the recording emission level with an oscilloscope and the like, and after that, converting the obtained signals to a suitable data format, then inputting them into CPU 5. A method of input can be easily achieved, for example, by using an on/off function of a switch having a predetermined bit width.

Note that, in FIG. 1, only structural components which are necessary to explain Embodiment 1 of the present invention are described and other structural components such as a focus, a control unit for tracking, an optical system of a pickup and the like are omitted. As the structure of the optical pickup, a structure comprising optical components is possible. The optical components may be the laser 7, for example, a diffraction grating, an objective lens, a collimating lens, a half mirror, and a light-sensitive element.

In addition, the programmable delay line 2 and the programmable delay line 3, CPU 5, the laser power controlling/driving circuit 4, the power setting unit 6 and the like make up the control unit controlling the emission of the laser 7 by using the recording compensation value determined in accordance with the emission property of the laser 7.

In addition, the photo detector 13, the AD converter 14 and the like make up a measurement unit measuring the leading edge period or the trailing edge period of the laser 7.

Operations

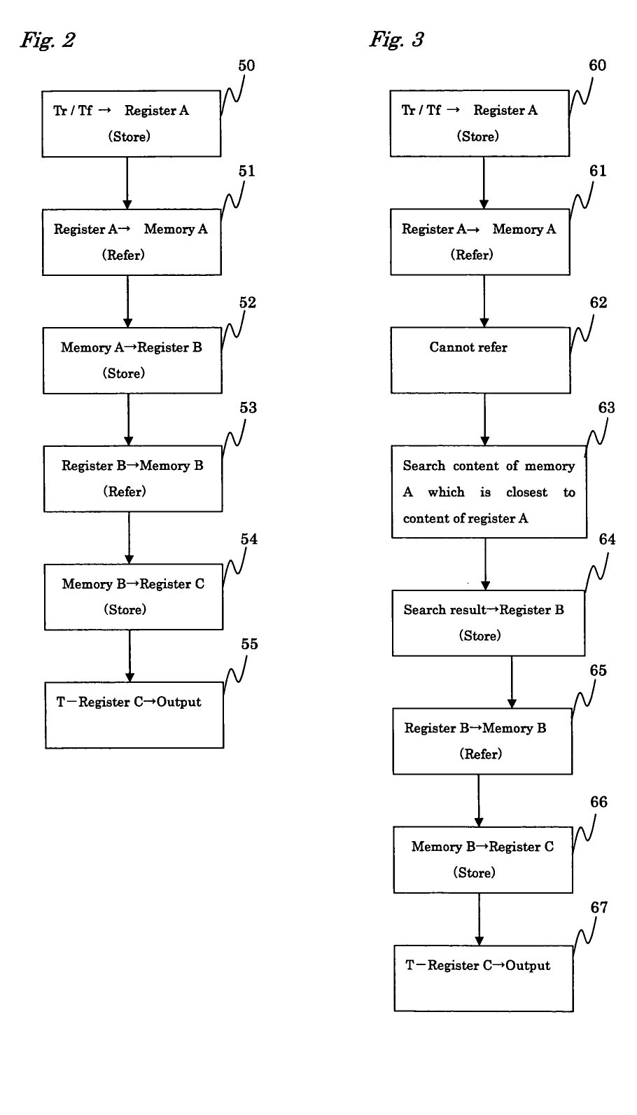

Next, an operation of CPU 5 in the optical disk device of the present invention constructed as shown in FIG. 1 will be explained using the flow chart in FIG. 2. Note that, because the register A and B shown in FIG. 2 are concerned in the description of a program which operates CPU 5, they are not shown in FIG. 1.

First, in step 50, CPU 5 performs a process of inputting data 10 in accordance with the leading edge period Tr and the trailing edge period Tf of laser actually used 7, and the data is stored in the register A. Next, in step 51, by using the content of the register A, one of the contents of the memory A, that is, one of a pair of a plurality of pairs of the leading edge period (Tr1-TrN) and the trailing edge period (Tf1-TfN) of the laser, is referred to and is stored in the register B in step 52. Then, in step 53, by using the content of the register B, one of the contents of the memory B is referred to, that is, recording compensation values (Trr1-TrrN, Tff1-TffN) which are referred to during each of the different leading edge periods and the trailing edge periods of the laser, and is stored in the register C in step 54. Finally, in step 55, the content of the register C is subtracted from the maximum amount of delay T of the programmable delay line and the value is output. Then the amount of delay, that is, the recording compensation value, is set relative to the programmable delay line 2 and programmable delay line 3 shown in FIG. 1.

From the explanation above, the operation of the optical disk device of the present Embodiment, which performs the recording compensation by referring to the leading edge period and the trailing edge period during the recording emission of the laser, becomes clear.

Effects

(1)

With the optical disk device of the present invention, it is possible to form a recording mark using a recording compensation value in accordance with the emission property (a leading/trailing edge period) of the laser actually used (in the present Embodiment, the laser 7 shown in FIG. 1). Therefore, performing a more suitable recording compensation and forming the mark at an appropriate recording position are also possible.

Note that, this effect can be obtained not only for an optical disk device having high-speed, but also for an optical disk device having the same speed as the conventional one.

(2)

Furthermore, as additional effects, the effects described below can also be obtained in the present invention.

Objects

In the technique explained using FIG. 6, stray capacitance of the laser driven by the recording pulse 103 is different in each of the lasers. Therefore, the leading edge period Tr of an emission level when transiting from a non-recorded state to a recorded state, and the trailing edge period Tr of an emission level when transiting from a recorded state to a non-recorded state, are different. Along with this difference, the above-mentioned Trr and Tff also become different.

The same is true when the laser is driven by the recording pulse 111; the recording compensation is performed on the recording pulse when Tr and Tf of each of the lasers are constant. In other words, when Tr and Tf are considered to be constant in the optical disk device carrying a laser which has different properties relating to Tr and Tf, if employing the recording compensation value determined by the same method explained using FIG. 6, then a shift from the suitable recording compensation value occurs. From the result, if forming the recording mark by using these optical disk devices, it is difficult to ensure compatibility of the length of the formed recording mark and the position of the front-end and the back-end among these optical disk devices.

Furthermore, in a system in which a high recording transmission rate is required, the ratio of the basic time unit t of the recording pulse to the leading edge period Tr of the recording emission level of the laser or the trailing edge period Tf of the recording emission level of the laser tends to increase. Therefore, an error caused by a difference between Tr and Tf of each of the lasers tends to increase. Along with the increases, the above-mentioned errors of Trr and Tff also increase and it is also difficult to ensure compatibility of the length of the formed recording mark and the position of the front-end and the back-end among these optical disk devices.

In other words, if the error of Tr and Tf of the laser is not considered in determining the recording compensation value, it is difficult to ensure compatibility of the length of the formed recording mark on the optical disk and the position of the front-end and the back-end among these different optical disk devices, more specifically, among the optical disk devices carrying a laser which has different properties of Tr and Tf.

Effects of the Present Invention

On the other hand, in the present invention, a suitable recording compensation value is performed in accordance with the leading edge period Tr and the trailing edge period Tf of the laser actually used (in FIG. 1, the laser 7).

Therefore, the difference in the length of the formed recording mark and the difference in the position of the front-end and the back-end are reduced, that is caused by the difference of the leading edge period or the trailing edge period of the laser during the recording emission of each laser among the different optical disk devices. In other words, keeping the recording properties between the different optical disk devices constant, that is, ensuring compatibility becomes possible. As a result, ensuring compatibility is also possible for reproducing the recorded data.

Examples of Modification

(1)

In the optical disk device shown in FIG. 1, the recording compensation value was determined in accordance with the leading edge period Tr and the trailing edge period Tf of the laser.

Here, the optical disk device is also capable of determining the recording compensation value in accordance with other emission properties of the laser.

(2)

In the optical disk device shown in FIG. 1, the leading edge Tr and the trailing edge Tf of the laser 7 is actually measured.

Here, the leading edge period Tr and the trailing edge period Tf of the laser 7 can also be evaluated from the model number of the laser 7 or values showing other characteristics, without the actual measurement.

### Embodiment 2

Next, Embodiment 2 of the optical disk device of the present invention will be explained.

Structures and Operations

The structure of Embodiment 2 is almost the same as Embodiment 1 described above.

In Embodiment 2, when the leading edge period Tr and the trailing edge period Tf of the laser actually used 7 are not identical to the content of the memory A included in CPU 5, a way of dealing with this issue is provided as follows.

The method is explained by using the flow chart in FIG. 3.

First, a process of inputting data 10 is performed. The data 10 is in accordance with the leading edge period Tr and the trailing edge period Tf of the laser 7 which is actually used in step 60. Then the data is stored in a register A. Next, in step 61, the content of the memory A which is included in the contents of the register A, in other words, one of a pair of a plurality of pairs of the leading edge period (Tr1-TrN) or the trailing edge period (Tf1-TfN) of the laser are referred to. If the referred values are identical, steps 51 to 55 shown in FIG. 2 are performed. On the other hand, as shown in step 62, if the values are not identical, the content of the memory A which is the closest to the content of the register A is searched for in step 63. The search result is stored in the register B in step 64. Next, in step 65, the content of the memory B which is included in the contents of the register B, in other words, the recording compensation value (Trr1-TrrN, Tff1-TffN) is referred to, that is, the value is referred to by each of the different leading edge periods and the trailing edge periods of the laser. It is stored in the register C in step 66.

Finally, in step 67, a value subtracting the content of the register C from the maximum amount of delay T of the programmable delay line is output. As a result, the amount of delay, in other words the recording compensation value, is set for the programmable delay line 2 and the programmable delay line 3 shown in FIG. 1.

Effects

In the optical disk device of the present Embodiment, almost the same effects of the optical disk device of Embodiment 1 can be obtained.

Particularly, as it is clear from the explanation above, a set recording compensation value is a value which is the most appropriate for the leading edge period and the trailing edge period of the laser and is the closest value for the leading edge period Tr and the trailing edge period Tf of the laser actually used 7, and the value is within a certain range of error.

Therefore, according to the difference in the leading edge period and the trailing edge period of the laser during the recording emission of each laser among the optical disk devices, it is possible to reduce the range of error for the length of the formed recording mark and the position of the front-end and the back-end. In other words, keeping the recording properties of the different optical disk devices constant is possible within a certain range of errors.

### Embodiment 3

Next, Embodiment 3 of the optical disk device of the present invention will be explained.

Structures and Operations

The structure of Embodiment 3 is almost the same as Embodiment 1 described above.

In Embodiment 3, when the leading edge period Tr and the trailing edge period Tf of the laser actually used 7 are not identical to the content of the memory A included in CPU 5, a way of dealing with this issue (in aspects which are different from the way of Embodiment 2) is provided as follows.

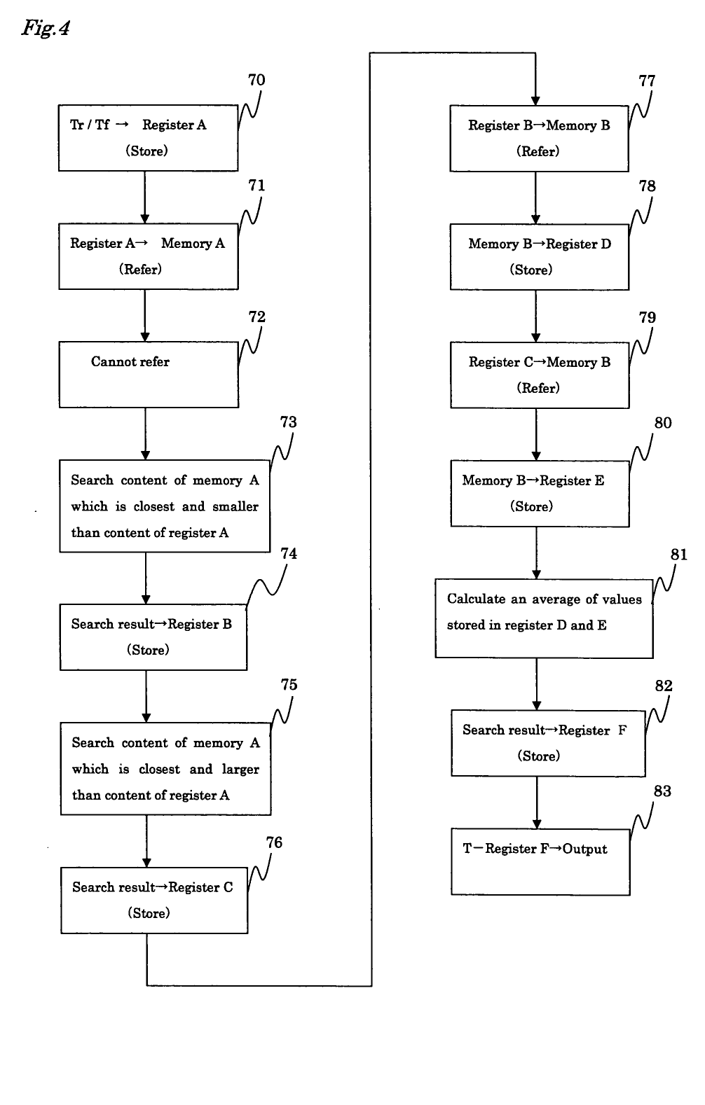

The method is explained by using the flow chart in FIG. 4.

First, a process of inputting data 10 is performed. The data 10 is in accordance with the leading edge period Tr and the trailing edge period Tf of the laser 7 which are actually used in step 70. Then the data is stored in a register A. Next, in step 71, the content of the memory A which is included in the content of the register A, in other words, one of a pair of a plurality of pairs of the leading edge period (Tr1-TrN) or the trailing edge period (Tf1-TfN) of the laser are referred to. If the referred values are identical, steps 51 to 55 shown in FIG. 2 are performed. On the other hand, as shown in step 72, if the values are not identical, the content of the memory A which is the closest to and smaller than the content of the register A is searched for in step 73. The search result is stored in the register B in step 74. Next, the content of the memory A which is the closest to and larger than the content of the register A is searched for in step 75, and the search result is stored in the register C in step 76. Furthermore, in step 77, the content of the memory B which is included in the content of the register B, in other words, the recording compensation value (Trr1-TrrN, Tff1-TffN) is referred to, that is the value is referred to by each of the different leading edge period and the trailing edge period of the laser. It is stored in the register D in step 78. In addition, in step 79, the content of the memory B which is included in the content of the register C, in other words, the recording compensation value (Trr1-TrrN, Tff1-TffN) is referred to, that is the value is referred to by each of the different leading edge period and the trailing edge period of the laser. It is stored in the register E in step 80. Then, in step 81, an average of the contents of the register D and the register E is calculated. Then the result is stored in the register F in step 82. Finally, in step 83, a value subtracting the content of the register F from the maximum amount of delay T of the programmable delay line is output. As a result, the amount of delay, in other words the recording compensation value, is set for the programmable delay line 2 and the programmable delay line 3 shown in FIG. 1.

Note that, the average value calculated in the step 81 can be a simple average or a weighted average of register D and register E. Here, the weighted average can be, for example, calculated by dividing the values stored in the register D and the register E internally according to an internal division ratio of the value stored in the register A, which is relative to the values stored in the register B and the register C.

Effects

In the optical disk device of the present Embodiment, almost the same effects of the optical disk device of Embodiment 1 can be obtained.

Particularly, as is clear from the explanation above, a set recording compensation value is the average value of the referred recording compensation value which is the closest to the leading edge period and the trailing edge period of the laser actually used 7, and the average value is the most appropriate one within a certain range of error.

Therefore, the error range obviously becomes smaller than the error range in Embodiment 2. Thus, according to the difference in the leading edge period and the trailing edge period of the laser during the recording emission of each laser among the optical disk devices, it is possible to reduce the range of error for the length of the formed recording mark and the position of the front-end and the back-end, which is smaller than the error in Embodiment 2. In other words, keeping the recording properties of the different optical disk devices constant within a smaller range of errors than the errors in Embodiment 2 is possible.

### Embodiment 4

In the optical disk of the present invention, the recording compensation value explained in each Embodiment above, in other words a plurality of pairs of the recording compensation value (Trr1-TrrN, Tff1-TffN) determined to be appropriate for the different leading edge period (Tr1-TrN) and the trailing edge period (Tf1-TfN) during the recording emission of the laser, are recorded on the predetermined area beforehand.

As described below in Embodiment 5 for the optical disk device of the present invention, when the optical disk of the present invention is used, additional effects than those described in Embodiments 1 to 3 for the optical disk device of the present invention can be obtained.

Note that, a predetermined area where the above-mentioned recording compensation value is recorded beforehand can be a control track which is defined by various disk standards, or can be a track which has a certain physical address on the optical disk.

Hereinafter, Embodiment 5 will be explained.

### Embodiment 5

Structures

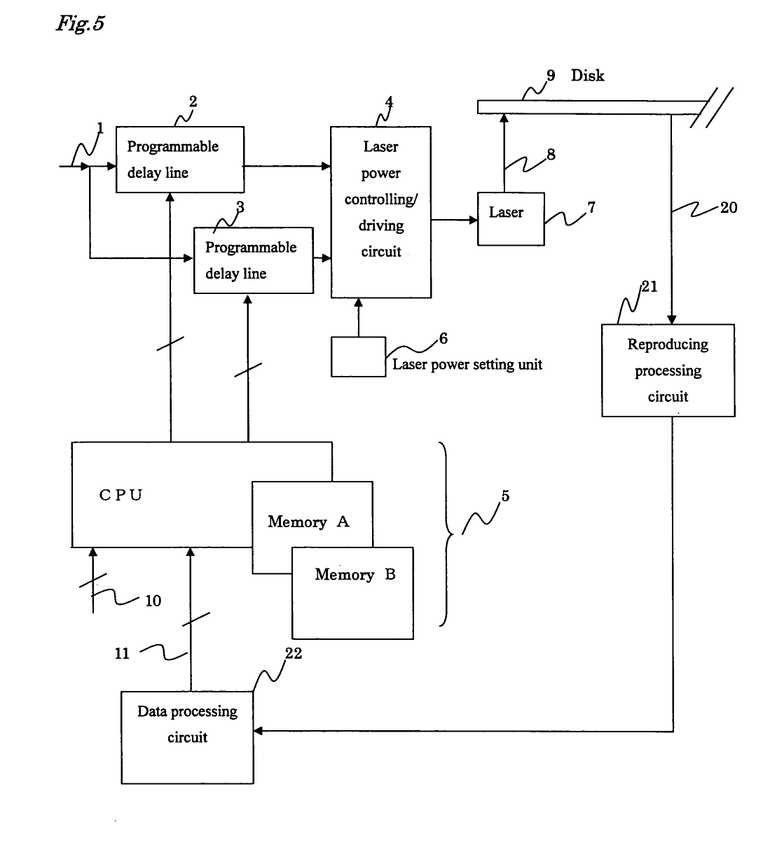

FIG. 5 shows an optical disk device of Embodiment 5 of the present invention, particularly a part of the structure related to the recording compensation. In FIG. 5, the same as in FIG. 1, structural components which are necessary to explain Embodiment 5 of the present invention are only described and other structure components such as, a focus, a control unit of tracking, an optical system of a pickup and the like are omitted.

In FIG. 5, reference numeral 1 is a recording pulse. The recording pulse 1 is input into each of a programmable delay line 2 and a programmable delay line 3 in which the amount of delay can arbitrarily be set. The programmable delay line 2 delays the recording start position of the recording pulse 1, and the programmable delay line 3 delays the recording end position of the recording pulse 1, which has the same structural components described in Embodiment 1.

In addition, reference numeral 5 is a CPU for controlling the setting of the predetermined amount of delay in accordance with the programmable delay line 2 and the programmable delay line 3, and includes a memory A and a memory B inside. Note that, CPU 5 is not limited to such structure, and can also be connected with the memory A and the memory B through a bus or the network.

In addition, reference numeral 10 is input data into the CPU 5. The data is in accordance with the leading edge period Tr and the trailing edge period Tf of laser actually used 7. Because the detail description of the input data 10 is the same as described in Embodiment 1, here, the explanation is omitted.

Note that, regarding CPU 5, the difference from Embodiment 1 is described below. That is, in Embodiment 1 (i.e. FIG. 1), the memory A and the memory B operated as a read only memory. On the other hand, in the present Embodiment (i.e. FIG. 5), the memories operate as a rewritable memory. The function will be described later.

On the other hand, the recording pulse with a delay process by the programmable delay line 2 and the programmable delay line 3, as described in FIG. 1 of Embodiment 1, is input into the laser power controlling/driving circuit 4. The laser power controlling/driving circuit 4 controls/drives the laser 7 in accordance with a level of a power setting unit 6. The laser 7 emits the laser beam 8, and a recording mark is formed on a disk 9.

The disk 9 is the optical disk shown in Embodiment 4. In the predetermined area on the disk 9, a plurality of pairs of the recording compensation value (Trr1-TrrN, Tff1-TffN) which is determined appropriately for the different leading edge periods (Tr1-TrN) and the trailing edge periods (Tf1-TfN) during the recording emission of the laser is recorded beforehand.

In FIG. 5, reference numeral 20 shows a reproducing signal from the disk 9.

For the reproducing signal 20, a reproducing signal from the predetermined area where a plurality pairs of the recording compensation value are recorded is processed at a reproducing process circuit 21 and a data process circuit 22. Furthermore, the signal after this process becomes input data 11 to CPU 5 (the data is not equal to the input data 10 of above-mentioned CPU 5) and is input into CPU 5. Thus, the input data 11 to CPU 5 is made by transforming a plurality pairs of the recording compensation value (Trr1-TrrN, Tff1-TffN) (relating to leading edge periods (Tr1-TrN) and the trailing edge periods (Tf1-TfN) of the laser during the recording emission) to a predetermined data format.

CPU 5 performs the program process which was determined beforehand, and for the input data 11, information related to a plurality pairs of the leading edge period and trailing edge period during the recording emission of the laser (in other words, Tr1-TrN, Tf1-TfN) is stored in the memory A. In addition, CPU 5 stores the contents of memory A in the memory B. In other words, it stores the recording compensation value referred to by each of the different leading edge periods (Tr1-TrN) and the trailing edge periods (Tf1-TfN) of the laser. That is, information related to the recording compensation values (Trr1-TrrN, Tff1-TffN) which is appropriate for each of the different leading edge periods and the trailing edge periods is stored.

From the structure presented above, the properties of the optical disk device in the present Embodiment is the same as explained in Embodiment 1.

Operations and Effects

According to the above-mentioned structure, the operation of performing the recording compensation to the recording pulse 1 and forming a recording mark on the optical disk 9 is as follows. The data 10 in accordance with the leading edge period Tr and the trailing edge period Tf of the laser actually used 7 is input into CPU 5. In CPU 5, by using a similar processing program as described in FIG. 2 of Embodiment 1, the recording compensation value is determined.

Thus, forming the recording mark is possible by using the optimized recording compensation value which is suitable for the leading edge period and trailing edge period during the recording emission of the laser actually used.

In addition, in another optical disk device, a suitable recording compensation value is chosen and determined by referring to a leading edge period or a trailing edge period of a laser which is actually used in the optical disk device.

Therefore, the difference in the length of the formed recording mark and in the position of the front-end and the back-end is reduced, which is caused by the difference of the leading edge period or the trailing edge period of the laser during the recording emission of each of the lasers among the different optical disk devices. In other words, keeping the recording properties among the different optical disk devices constant, that is ensuring compatibility, is possible. Furthermore, as a result, ensuring compatibility is also possible for reproducing the recorded data, which is the same effect as described in Embodiment 1.

In addition, if the contents of the memory A of CPU 5 are compared with the leading edge period Tr and the trailing edge period Tf of the laser actually used 7 (in other words, a plurality pairs of the leading edge period (Tr1-TrN) and trailing edge period (Tf1-TfN) during the recording emission of the laser stored based on the reproducing signal 20 from the optical disk 9) and are not identical, then almost the same process described in Embodiment 2 or Embodiment 3 can be applied. In other words, by performing the same process using the CPU 5 in FIG. 3 or FIG. 4 described in Embodiment 2 or 3, the same effects as explained in Embodiment 2 or Embodiment 3 can be obtained.

Furthermore, in the present Embodiment, a plurality of pairs of the recording compensation value, determined in accordance with appropriately for the leading edge period and the trailing edge period of the laser during the recording emission, are stored on the optical disk on which the recording mark is actually formed. Furthermore, based on information related to the stored recording compensation value, the recording compensation is performed.

Here, those recording compensation values can be a value which is unique to the optical disk. Thus, the values do not depend on the different leading edge period and the trailing edge period during the recording emission of the laser alone, but also the recording which handles the difference of the recording compensation value caused by the difference of the material of the optical disk which is slightly different depends on each of the manufacturers of the optical disks can be performed. Therefore, in addition to the effect of keeping the recording properties among the above-mentioned different optical disk devices constant, keeping the length of the recording mark, the start-end position and the back-end position of the recording mark formed on the optical disk more precise is also possible.

### Embodiment 6

Each functional block and the hardware structure in the block diagram shown in FIG. 1 or FIG. 5 are realized as an LSI which is a typical integrated circuit. Each of the blocks and the structures may be one individual chip, or may be one chip which is a part or the whole LSI.

For example, the CPU 5, the programmable delay line 2 and the programmable delay line 3 in FIG. 1 or FIG. 5 may be one chip. Note that, in this situation, the memory A and the memory B may be one chip with CPU 5 as an integrated unit, or they may be externally connected with CPU 5.

Here, a LSI is shown as the example; however, it is also called an IC, a system LSI, a super LSI and a ultra LSI depending on the difference of integrated degree.

In addition, because the method of the circuit integration is not limited to a LSI, the integration can be achieved by using a dedicated circuit or a general-purpose processor. After manufacturing the LSI, a programmable FPGA (Field Programmable Gate Array) or a reconfigurable processor can also be used, which are available for reconstructing a connection between circuit cells and for reconstructing the setting of an LSI internally.

Furthermore, if a circuit integration technique which replaces the conventional technique for LSI appears along with the development of a semiconductor technique or other techniques derived from the development, the technique can clearly be used for the integration of the functional blocks. For such techniques, applying biotechnology and the like is also possible.

(Additions)

Additional Contents

(Addition 1)

An optical disk device, in which a laser is driven by using a recording pulse which changes its pulse width and its pulse interval in accordance with the recording data; a front-end and a back-end position of a mark is controlled when recording data by forming the mark on an optical disk; and a recording compensation value is determined for a recording compensation to record the mark at an appropriate position which is dependent on the leading edge period and the trailing edge period of the laser during the recording emission.

(Addition 2)

The optical disk device of Addition 1, comprising a recording compensation table in which a plurality of pairs of the recording compensation value are recorded beforehand to appropriately provide the different leading edge period and trailing edge period of the laser during the recording emission, and wherein one pair of the recording compensation values chosen from the recording compensation table is referred to according to the leading edge period and the trailing edge period of the laser actually used during the recording emission.

(Addition 3)

The optical disk device of Addition 1, wherein one pair of the recording compensation values chosen from the recording compensation table is referred to according to the leading edge period and the trailing edge period of laser actually used during the recording emission.

(Addition 4)

The optical disk device of Addition 1, wherein two pairs of the recording compensation value are referred from the recording compensation table according to the leading edge period and the trailing edge period of the laser actually used during the recording emission, and an average value of the two pairs of the recording compensation value is used as the recording compensation value.

(Addition 5)

An optical disk having a predetermined area on which a plurality pairs of the recording compensation value is recorded and the plurality of pairs is provided in accordance with the leading edge period and the trailing edge period of the laser during the recording emission.

(Addition 6)

An optical disk device, wherein one pair of recording compensation values is referred to chosen from a plurality of pairs of the recording compensation value determined appropriately for the leading edge period and the trailing edge period of the laser during the recording emission which is recorded in the predetermined area on the optical disk, and the values are referred to based on the leading edge period and the trailing edge period of the laser actually used during the recording emission.

(Addition 7)

The optical disk device of Addition 6, comprising referring one pair of recording compensation values chosen from a plurality of pairs of recording compensation values determined appropriately for the leading edge period and the trailing edge period of the laser during the recording emission which is recorded in the predetermined area on the optical disk, and the values are referred to based on the closest values of the leading edge period and the trailing edge period of the laser actually used during the recording emission.

(Addition 8)

The optical disk device of Addition 6, wherein two pairs of recording compensation values are referred to chosen from a plurality of pairs of recording compensation values determined appropriately for the leading edge period and the trailing edge period of the laser during the recording emission which is recorded in the predetermined area on the optical disk, and the values are referred to based on the closest values of the leading edge period and the trailing edge period of the laser actually used during the recording emission; and wherein the average of the two pairs of recording compensation value is defined as the recording compensation value.

Additional Explanations

In order to solve the conventional problems, in the optical disk device of the present invention, the recording compensation value for the recording compensation is determined based on the leading edge period and the trailing edge period of the laser during the recording emission.

In addition, in the optical disk device of the present invention, a plurality of pairs of the recording compensation value, which is determined appropriately for the different leading edge period and the trailing edge period of the laser during the recording emission, are recorded in a predetermined area beforehand.

In addition, in the optical disk device of the present invention, the recording compensation value, which is referred to by the unique leading edge period and the unique trailing edge period during the recording emission of the laser carried in the optical disk, is one of the pairs of a plurality of pairs of the recording compensation value which is appropriate for a laser property read out by reproducing the certain area on the optical disk by using the optical disk device.

From the present structure, because it is possible to choose the most suitable recording compensation value in accordance with the leading edge period or the trailing edge period during the emission at the laser generation units, the length and the position of the front-end and the back-end of the recording mark being formed can always be optimized.

According to the optical disk device and the optical disk of the present invention, the differences in the leading edge period and the trailing edge period of the laser during the recording emission among the different optical disk devices do not cause a difference in the length of the formed recording mark or the position of the front-end and the back-end. That is, keeping the recording properties in different optical disk devices constant, or in other words, ensuring the compatibility with the devices, is possible. As a result, ensuring the compatibility with reproducing properties of the recording data is also possible.

An optical disk device and an optical disk of the present invention are useful in fields which require the provision of an optical disk device which is capable of forming a recording mark at a more suitable position by using a more suitable recording compensation value, such as an optical disk drive, an optical disk recorder and the like, or information recording media for those devices.

1. An optical disk device for recording recording data by forming a mark on
an optical disk using a recording pulse in accordance with the recording data, comprising:
an optical pickup including a laser generation unit which emits a laser light in accordance with the recording pulse and an optical component which guides the laser light to the optical disk; and
a control unit controlling the emission at the laser generation unit by using a recording compensation value determined in accordance with an emission property of the laser generation unit.

2. The optical disk device of claim 1, wherein the emission property is a leading edge period or a trailing edge period during the emission at the laser generation unit.

3. The optical disk device of claim 2, further comprising:
a memory unit storing a plurality of candidates for the recording compensation value which are determined for each of a plurality of leading edge periods having different values or each of a plurality of trailing edge periods having different values, and
wherein the control unit determines the recording compensation value which is used in controlling the emission at the laser generation unit, by choosing the value from the plurality of candidates for the recording compensation value stored in the memory unit, based on the leading edge period or the trailing edge period during the emission at the laser generation unit.

4. The optical disk device of claim 3, further comprising:
a measurement unit measuring the leading edge period or the trailing edge period during the emission at the laser generation unit, and
wherein the control unit obtains the leading edge period or the trailing edge period during the emission at the laser generation unit from the measurement unit.

5. The optical disk device of claim 3, wherein the control unit chooses a candidate for the recording compensation value as the recording compensation value from the plurality of candidates for the recording compensation value stored in the memory unit, wherein the candidate is determined based upon a closest value of the leading edge period or the trailing edge period during the emission at the laser generation unit.

6. The optical disk device of claim 3, wherein the control unit chooses two candidates for the recording compensation value from the plurality of candidates for the recording compensation value stored in the memory unit, wherein the two candidates are determined based upon two closest values of the leading edge period or the trailing edge period during the emission at the laser generation unit, and determines an average value of the two chosen candidates for the recording compensation value as the recording compensation value.

7. The optical disk device of claim 2, wherein the control unit obtains a plurality of candidates for the recording compensation value from the optical disk, wherein candidates are determined based upon each of a plurality of leading edge periods having different values or each of a plurality of trailing edge periods having different values, and determines the recording compensation value, which is used in controlling the emission at the laser generation unit, from the plurality of candidates for the recording compensation value based on the leading edge period or the trailing edge period during the emission at the laser generation unit.

8. The optical disk device of claim 7, further comprising:
a measurement unit measuring the leading edge period or the trailing edge period during the emission at the laser generation unit, and
wherein the control unit obtains the leading edge period or the trailing edge period during the emission at the laser generation unit from the measurement unit.

9. The optical disk device of claim 7, wherein the control unit chooses a candidate for the recording compensation value as the recording compensation value from the plurality of candidates for the recording compensation value obtained from the optical disk, wherein the candidate is determined based upon the closest value of a leading edge period or a trailing edge period during the emission at the laser generation unit.

10. The optical disk device of claim 7, wherein the control unit chooses two candidates for the recording compensation value from the plurality of candidates for the recording compensation value obtained from the optical disk, wherein the two candidates are determined based upon two closest values of the leading edge period or the trailing edge period during the emission at the laser generation unit, and determines an average value of the two chosen candidates for the recording compensation value as the recording compensation value.

11. A semiconductor device for controlling emission timing at a laser generation unit in which a laser light is emitted in accordance with a pulse signal, comprising:
an amount-of-delay determining unit determining the amount of delay of the pulse signal by using a predetermined recording compensation value in accordance with an emission property of the laser generation unit; and
a delay execution unit delaying the pulse signal by using the amount of delay determined at the amount-of-delay determining unit.

12. An optical disk on which recording data is recorded by forming a mark by a laser emission,
wherein each of a plurality of determined candidates for recording compensation values are recorded beforehand on a predetermined area in accordance with a plurality of different values of a laser emission property.

13. A recording method used in an optical device for recording the recording data by forming a mark on an optical disk by using a recording pulse in accordance with the recording data, the method comprising:
obtaining an emission property of a laser generation unit which emits a laser light in accordance with the recording pulse; and
controlling an emission at the laser generation unit by using a recording compensation value determined in accordance with the emission property.

14. The optical disk device of claim 4, wherein the control unit chooses a candidate for the recording compensation value as the recording compensation value from the plurality of candidates for the recording compensation value stored in the memory unit, wherein the candidate is determined based upon a closest value of the leading edge period or the trailing edge period during the emission at the laser generation unit.

15. The optical disk device of claim 4, wherein the control unit chooses two candidates for the recording compensation value from the plurality of candidates for the recording compensation value stored in the memory unit, wherein the two candidates are determined based upon two closest values of the leading edge period or the trailing edge period during the emission at the laser generation unit, and determines an average value of the two chosen candidates for the recording compensation value as the recording compensation value.

16. The optical disk device of claim 8, wherein the control unit chooses a candidate for the recording compensation value as the recording compensation value from the plurality of candidates for the recording compensation value obtained from the optical disk, wherein the candidate is determined based upon the closest value of a leading edge period or a trailing edge period during the emission at the laser generation unit.

17. The optical disk device of claim 8, wherein the control unit chooses two candidates for the recording compensation value from the plurality of candidates for the recording compensation value obtained from the optical disk, wherein the two candidates are determined based upon two closest values of the leading edge period or the trailing edge period during the emission at the laser generation unit, and determines an average value of the two chosen candidates for the recording compensation value as the recording compensation value.
